(19) United States
(12) Patent Application Publication
(10) Pub. No.: US 2020/0213423 A1
(43) Pub. Date: Jul. 2, 2020

(54) SYSTEMS, METHODS, AND COMPUTING PLATFORMS FOR CONTEXT IDENTIFIER ALLOCATION FOR DATA PACKET HEADER COMPRESSION

(71) Applicant: QUALCOMM Incorporated, San Diego, CA (US)

(72) Inventors: Rahul JAIN, Sawai Madhopur (IN); Deepak SAH, Hyderabad (IN); Ganesh Babu KAMMA, Hyderabad (IN); Saket BATHWAL, Hyderabad (IN); Nagamanikandan SIVAKUMAR, Hyderabad (IN)

(21) Appl. No.: 16/238,360

(22) Filed: Jan. 2, 2019

(51) Int. Cl. H04L 29/06; H04W 28/06

(52) U.S. Cl. CPC H04L 69/04; H04L 69/22; H04L 65/608; H04L 69/18; H04W 28/06

(57) ABSTRACT

Systems, methods, and computing platforms for context identifier allocation for data packet header compression are provided. Exemplary implementations may: obtain a first packet of a stream to be sent using a header compression protocol; determine a context identifier (CID) to associate with the stream based, at least in part, on a packet type of the first packet; generate a compressed header for the first packet according to the header compression protocol and based on the determined CID; and transmit the first packet with the compressed header.

### INTRODUCTION

### Field of the Disclosure

Aspects of the present disclosure relate to wireless communications, and more particularly, to techniques for context identifier allocation for data packet header compression.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., which may be referred to as a base station, 5G NB, next generation NodeB (gNB or gNodeB), TRP, etc.). A base station or distributed unit may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. New Radio (NR) (e.g., 5G) is an example of an emerging telecommunication standard. NR is a set of enhancements to the LTE mobile standard promulgated by 3GPP. It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Aspects of the present disclosure provide a method for wireless communications by a first device. The method generally includes obtaining a first packet of a stream to be sent using a header compression protocol, determining a context identifier to associate with the stream based, at least in part, on a packet type of the first packet, generating a compressed header for the first packet according to the header compression protocol and based on the determined CID, and transmitting the first packet with the compressed header.

Aspects of the present disclosure also provide apparatus, methods, processing systems, and computer readable mediums for performing the operations described above.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system.

FIG. 2 is a block diagram illustrating an example logical architecture of a distributed radio access network (RAN).

FIG. 3 is a diagram illustrating an example physical architecture of a distributed RAN.

FIG. 4 is a block diagram conceptually illustrating a design of an example base station (BS) and user equipment (UE).

FIG. 5 is a diagram showing examples for implementing a communication protocol stack.

FIG. 6 is a block diagram of an exemplary device that supports RoHC techniques in accordance with aspects of the present disclosure.

FIG. 7 illustrates example operations performed by a first device, according to aspects of the present disclosure.

FIG. 8 is a graph illustrating the efficiency of an exemplary implementation in accordance with certain aspects of the present disclosure.

FIG. 9 illustrates an example system configured for wireless communications by a first device, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for context identifier allocation for data packet header compression.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (SGTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

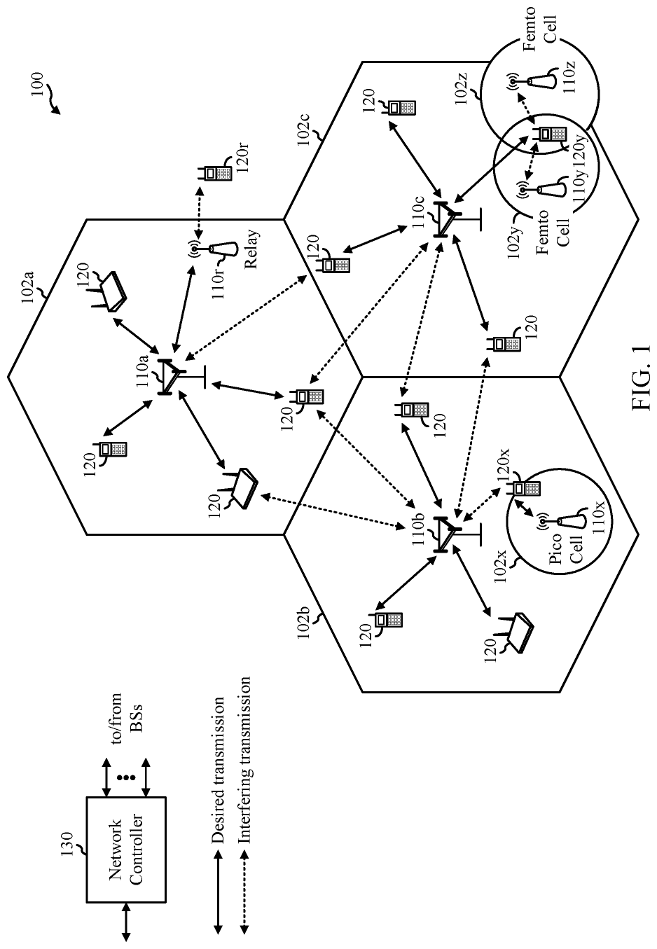

FIG. 1 illustrates an example wireless communication network 100 in which aspects of the present disclosure may be performed. For example, the wireless communication network 100 may be a New Radio (NR) or 5G network.

As illustrated in FIG. 1, the wireless network 100 may include a number of base stations (BSs) 110 and other network entities. A BS may be a station that communicates with user equipments (UEs). Each BS 110 may provide communication coverage for a particular geographic area. In 3GPP, the term “cell” can refer to a coverage area of a Node B (NB) and/or a Node B subsystem serving this coverage area, depending on the context in which the term is used. In NR systems, the term “cell” and next generation NodeB (gNB), new radio base station (NR BS), 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A base station (BS) may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled, wherein a scheduling entity (e.g., a base station) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

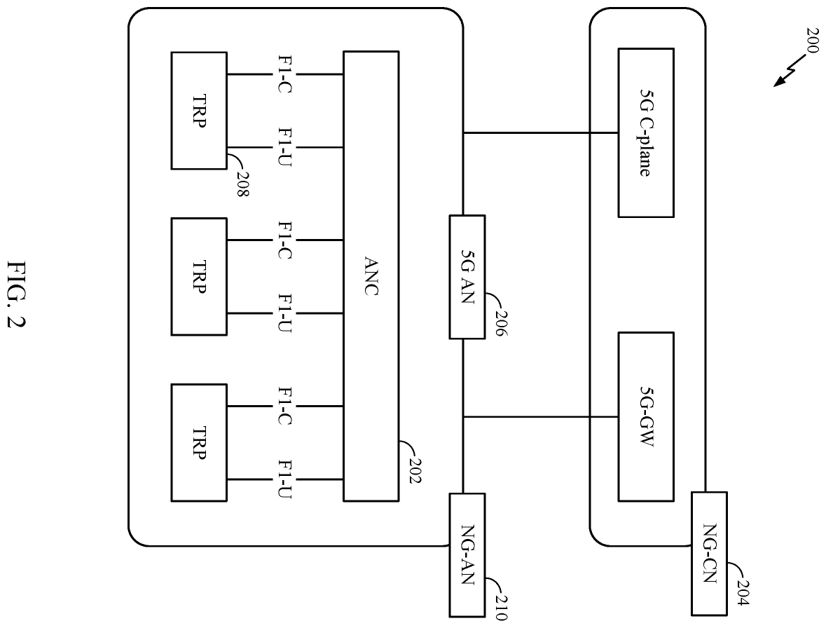

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more transmission reception points (TRPs) 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

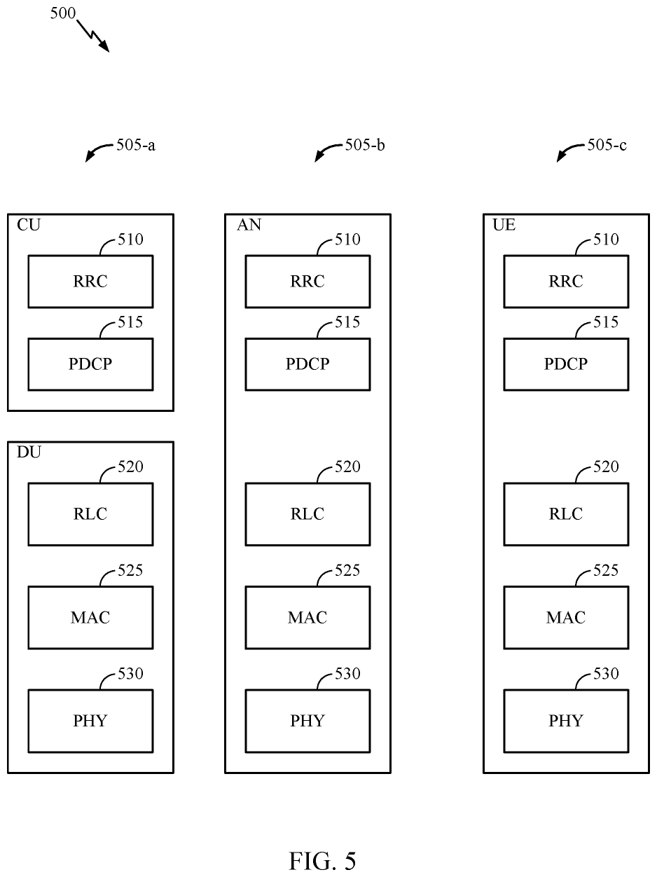

Logical functions may be dynamically distributed in the logical architecture of distributed RAN 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

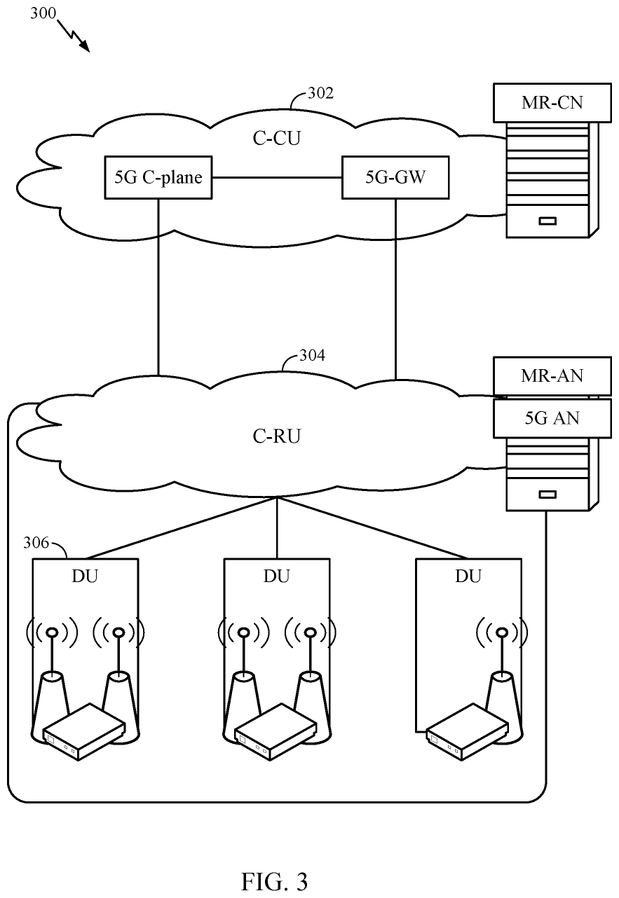

FIG. 3 illustrates an example physical architecture of a distributed Radio Access Network (RAN) 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

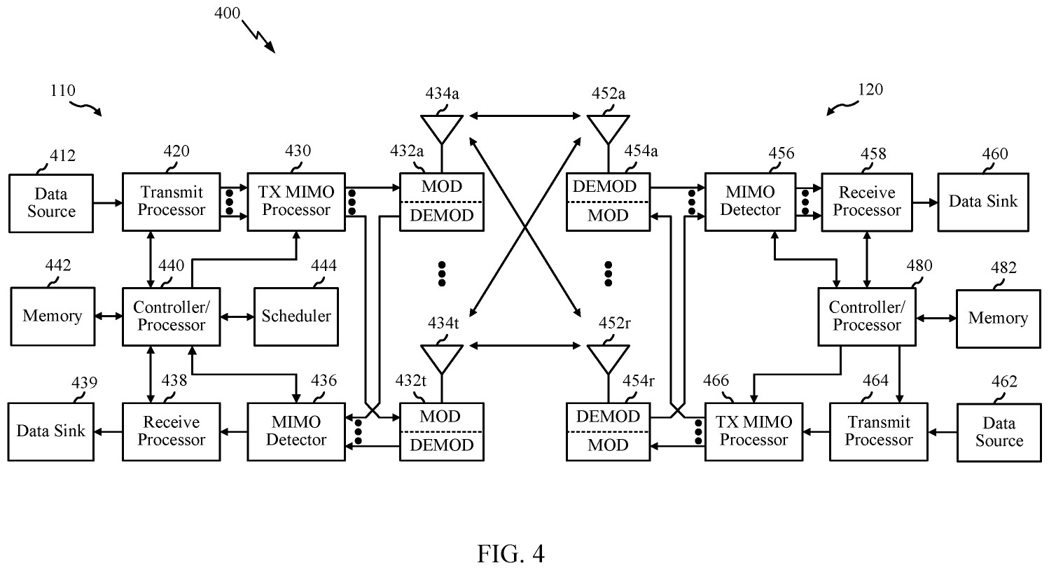

FIG. 4 illustrates example components of BS 110 and UE 120 (as depicted in FIG. 1), which may be used to implement aspects of the present disclosure. For example, antennas 452, processors 466, 458, 464, and/or controller/processor 480 of the UE 120 and/or antennas 434, processors 420, 430, 438, and/or controller/processor 440 of the BS 110 may be used to perform the various techniques and methods described herein.

At the BS 110, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at UE 120, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the base station 110 and the UE 120, respectively. The processor 440 and/or other processors and modules at the BS 110 may perform or direct the execution of processes for the techniques described herein. The memories 442 and 482 may store data and program codes for BS 110 and UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a wireless communication system, such as a 5G system (e.g., a system that supports uplink-based mobility). Diagram 500 illustrates a communications protocol stack including a Radio Resource Control (RRC) layer 510, a Packet Data Convergence Protocol (PDCP) layer 515, a Radio Link Control (RLC) layer 520, a Medium Access Control (MAC) layer 525, and a Physical (PHY) layer 530. In various examples, the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples, the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device. In the second option, RRC layer 510, PDCP layer 515, RLC layer 520, MAC layer 525, and PHY layer 530 may each be implemented by the AN. The second option 505-b may be useful in, for example, a femto cell deployment.

Regardless of whether a network access device implements part or all of a protocol stack, a UE may implement an entire protocol stack as shown in 505-c (e.g., the RRC layer 510, the PDCP layer 515, the RLC layer 520, the MAC layer 525, and the PHY layer 530).

In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing.

### Voice Over Long Term Evolution (VoLTE)

Voice over Long Term Evolution (VoLTE) is a voice over IP protocol that enables voice data to be transmitted between VoLTE-enabled devices as data packets rather than using a circuit switching protocol to transmit voice data. For VoLTE, packets may be delivered using Real Time Transport Protocol (RTP) over User Datagram Protocol/Internet Protocol (UDP/IP). RTP is used in conjunction with RTP Control Protocol (RTCP). RTP carries the media streams (e.g., audio and video, voice), and RTCP sends control packets between VoLTE-enabled devices, monitors transmission statistics and quality of service, and aids synchronization of multiple streams.

A voice packet may include fields indicating a payload type, sequence number, time stamp, and synchronization source identifier. The payload type field may include information relating to payload format and encoding types (e.g., from Session Description Protocol (SDP) information). The sequence number field may be incremented with each successive packet and may be used to detect packet loss. Time synchronization, indicated by the time stamp and a sampling rate defined in the RTP profile being used, may be used to enable real-time playback of the transmitted audio. Finally, the synchronization source identifier field may be used to identify a source stream within a session.

Robust Header Compression (RoHC) may be used to improve bandwidth efficiency for VoLTE operations. While an uncompressed VoIP packet may comprise between 24 and 60 bits for header information and a payload of 32-33 bytes, depending on a coding standard, a VoIP packet with RoHC compression may comprise a 3-4 byte header. With RoHC compression, headers of the data packets in the data stream may be compressed to reduce overhead during transmission by removing certain contextual information from the packet header. In other words, because information may not change for some time (e.g., for a duration VoLTE call), the packet header may be compressed by removing this information.

To establish a stream of data packets between a RoHC compressor and a RoHC decompressor, the compressor and the decompressor may first establish a context for the data stream. The context is the state that the compressor and the decompressor maintain in order to correctly compress or decompress the headers of the packets in the stream. Each context is identified using a context identifier (CID). The context may include information from previous headers in data stream, such as static fields and reference values for compression and decompression. The context may further include information indicating the change behavior of dynamic values, such as, for example, an inter-packet increase in sequence number or timestamps. A value may be associated with the CID, where the value may identify a state to be maintained by a corresponding compressor and decompressor to compress and decompress, respectively, the data contained in the data stream. Context information is conceptually kept in a table, and this table is indexed using the CID value, which is sent along with compressed headers and feedback information.

Accordingly, all RoHC packet types have a header format comprising the following: an optional Add-CID octet (which includes 4 bits of CID); an octet with the ROHC packet type and indication; one or two octets of CID, and the body of the packet. The RoHC headers can either start with a packet type indication or have a packet type indication immediately following an Add-CID octet. When the RoHC channel is configured with a small CID space, if the Add-CID immediately precedes the packet type indication, the packet has the CID of the Add-CID; otherwise, the packet has CID 0. The packet type indication specifies the type of the packet, such as RTP, RTCP, TCP, etc.

While the present disclosure discusses VoLTE specifically, this disclosure can be applied to other protocols that use RoHC or the IP Multimedia Subsystem (IMS) network, such as Voice-over-HSPA and Voice-over-NR (VoNR).

### Example RoHC Compressor and Decompressor

In an exemplary RoHC compression scheme, a UE as the compressor may be participating in a communication session with a BS as the decompressor, and may transmit an initial packet to the base station in a data packet stream. The initial packet may be a media data packet including as a payload, for example, video data or voice data. The packet may include a compressed header containing various information, including CID and packet type. In another exemplary compression scheme, the BS as the compressor may transmit the initial packet in the data packet stream to the UE as the decompressor.

In the exemplary implementation, a compressor-decompressor pair maintains a context at each side for each packet stream. The context for each packet stream is identified by the same CID at the compressor and the decompressor. The context includes information from previous headers in the packet stream and other possible reference values for compression and decompression. Data describing the packet stream, such as information about how an IP Identifier field changes and inter-packet increases in sequence number or timestamp is also contained in a context.

Initially, a compressor and decompressor may not have an agreement on compressing or decompressing a certain packet stream. A compressor may send RoHC packets having static and dynamic information, including the CID, about a packet stream to the decompressor to establish a context. Once both static and dynamic fields are set up, a compressor need only send minimal information to advance the regular sequence of compressed header fields.

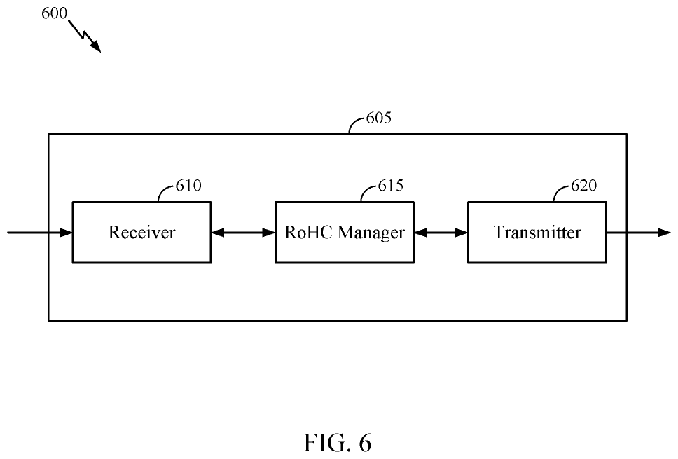

FIG. 6 shows a block diagram 600 of a wireless device 605 that supports RoHC techniques for context identifier allocation for data packet header compression in accordance with aspects of the present disclosure. Wireless device 605 may be an example of aspects of a UE 120 as described with reference to FIG. 1. Wireless device 605 may include receiver 610, RoHC manager 615, and transmitter 620. Wireless device 605 may also include a processor. Each of these components may be in communication with one another (e.g., via one or more buses). In another implementation, the wireless device may be an example of aspects of a BS 110 as described in reference to FIG. 1.

Receiver 610 may receive information such as packets, user data, or control information associated with various information channels (e.g., control channels, data channels, and information related to RoHC techniques, etc.). Information may be passed on to other components of the device 605. In some examples, the receiver 610 may be collocated with a transmitted 620 in a transceiver module.

RoHC manager 615 and/or at least some of its various sub-components may be implemented in hardware, software executed by a processor, firmware, or any combination thereof. If implemented in software executed by a processor, the functions of the RoHC manager 615 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The RoHC manager 615 and/or at least some of its various sub-components may be physically located at various positions, including being distributed such that portions of functions are implemented at different physical locations by one or more physical devices. In some examples, RoHC manager 615 and/or at least some of its various sub-components may be a separate and distinct component in accordance with various aspects of the present disclosure. In other examples, RoHC manager 615 and/or at least some of its various sub-components may be combined with one or more other hardware components, including but not limited to an input/output (I/O) component, a transceiver, a network server, another computing device, one or more other components described in the present disclosure, or a combination thereof in accordance with various aspects of the present disclosure.

In the exemplary implementation, the compressor comprises a RoHC manager 615. The RoHC manager can determine a RoHC context for the communications between the compressor and decompressor pair. The RoHC manager 615 can apply a RoHC compression to the communications, or headers thereof, to facilitate efficient transmission of the communications. In one example, the RoHC manager 615 can compress a header of a packet by removing or replacing one or more of the parameters in the packet header previously communicated to the decompressor. In another example, the RoHC manager 615 can provide a RoHC header for data packets.

In another exemplary implementation, the decompressor also comprises a RoHC manager 615. The decompressor receives the RoHC compressed communications, and can evaluate the context identifier in the RoHC header to determine the RoHC communications. The decompressor's RoHC manager 615 can decompress the communications, or related headers, based on the determined RoHC context.

Transmitter 620 may transmit signals generated by other components of the device. In some examples, the transmitter 620 may be collocated with a receiver 610 in a transceiver module. The transmitter 620 may include a single antenna, or it may include a set of antennas.

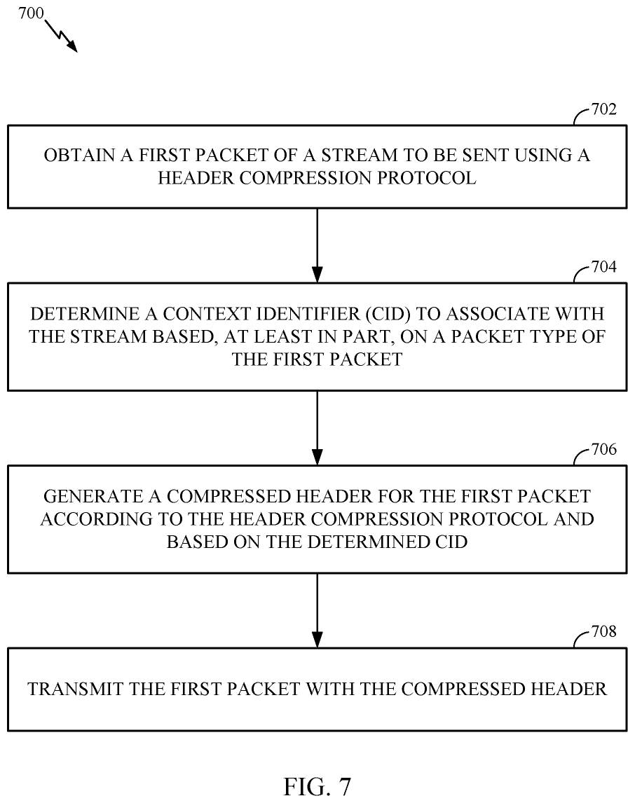

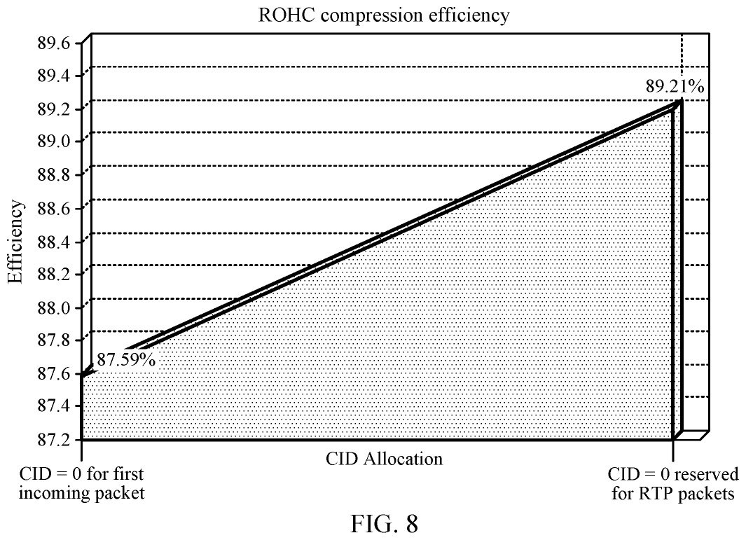

In some implementations, the device 605 may include various components (e.g., corresponding to means-plus-function components) configured to perform operations for the techniques disclosed herein, such as the operations illustrated in later described FIGS. 7 and 8. In these implementations, the device 605 includes a processing system coupled to a transceiver or a transmitter 620 and receiver 610, as shown in FIG. 6. The transmitter 620 and receiver 610 are configured to transmit and receive signals for the device 605 via an antenna, which as the various signal described herein. The processing system may be configured to perform processing functions for the device 605, including processing signals received and/or to be transmitted by the device 605.

In these implementations, the processing system includes a processor coupled to a computer-reading medium/memory via a bus. In certain aspects, the computer-readable medium/memory is configured to store instructions that when executed by the processor, cause the processor to perform the operations illustrated in FIG. 7, or other operations for performing the various techniques discussed herein.

In certain aspects, the processing system includes a RoHC manager (e.g., RoHC manager 615) for performing the operations illustrated in FIG. 7. The RoHC manager may be coupled to the processor via the bus. In certain aspects, the RoHC manager may be hardware circuits. In certain aspects, the RoHC manager may be a software component that is executed and run on the processor.

### Example Context Identifier Allocation for Header Compression

Certain implementations described herein relate to generating a compressed header for data packets in order to reduce payload size of the packets, for example, using the RoHC compression protocol described above.

Generally, when a device (a UE or a BS) receives a first incoming data packet with a RoHC-compressed header, the device does not have any information from the RoHC-compressed header about CID or the context, and so the device uses CID 0 for the first incoming packet because CID 0 has not been used with any other data packet streams. In fact, devices have used CID 0 for RTCP packets instead of RTP packets simply because the first incoming packet is an RTCP packet and CID 0 is allocated first. Unfortunately, once a particular stream of packet type is associated with a CID, the later incoming packets of the same stream are bound to use the same CID for the header compression and decompression. According to the RoHC protocol, packets using CID 0 use one octet less compared to CID with a value greater than or equal to 2 because there is no explicit Add-CID octet in the compressed header.

In a voice call (VoLTE, Voice-over-HSPA, VoNR, etc.), RTP packets are much more common than RTCP packets. For example, RTP packets generally have a frequency of about 20 ms and RTCP packets generally have a frequency of about 1 second, so the number of RTP packets being sent is much more as compared to the number of RTCP packets. Thus, during a voice call, when CID 0 is used for RTCP instead of RTP, the RTP packets contain the Add-CID octet to designate the CID and for each RTCP packet, almost 50 RTP packets are sent and roughly 49 additional bytes of Add-CID octet information is sent per second, resulting in unnecessary bandwidth consumption. Similarly, this problem applies to Transmission Control Protocol (TCP) packets and non-TCP packets.

Accordingly, in order to avoid the additional octet of Add-CID, aspects of the present disclosure propose a rule that dictates devices should reserve CID 0 for RTP (e.g., voice packets, RTP profile) or TCP, and CID 2 for RTCP (e.g., UDP profile) or non-TCP, in order to increase compressor efficiency resulting in better bandwidth utilization.

FIG. 7 illustrates example operations 700 for wireless communications with header compression, according to aspects of the present disclosure. Operations 700 may be performed by a first device, such as a UE 120 or BS 110. In some implementations, the operations 700 are performed by a RoHC Manager (e.g., RoHC Manager 615) of a UE or a BS. The operations of method 700 presented below are intended to be illustrative. In some implementations, method 700 may be accomplished with one or more additional operations not described, and/or without one or more of the operations discussed. Additionally, the order in which the operations of method 700 are illustrated in FIG. 7 and described below is not intended to be limiting.

At 702, the first device obtains a first packet of a stream to be sent using a header compression protocol. For example, the first device obtains the first packet via the receiver 610 before sending the first packet to the RoHC manager 615. In some aspects, the first packet can be a Real Time Protocol (RTP) packet, a Real Time Control Protocol (RTCP) packet, or a Transmission Control Protocol (TCP) packet. In some aspects, the first packed uses a header compression protocol, and this header compression protocol can be RoHC. In some aspects, the first device can be a user equipment (UE), and in other aspects, the first device can be a base station (BS). In some aspects, the stream is for a voice call. In some aspects, the voice call can be any of Voice-over-LTE (VoLTE), Voice-over-HSPA, and Voice-over-NR (VoNR). In other aspects, the stream is a TCP call.

At 704, the first device determines a context identifier (CID) to associate with the stream based, at least in part, on a packet type of the first packet. Because the RoHC manager 615 of the first device has no information and the first packet is the first packet the first device and the corresponding RoHC manager 615 has received, the RoHC manager and the corresponding first device allocates a CID value to the first packet and the corresponding stream. In some aspects, the CID is determined based on a rule that reserves a certain CID value for a certain packet type. In some aspects, the reserved CID value is 0. In some aspects, determining the CID involves assigning a zero CID value to the packet type and the packet type comprises RTP. For example, in some aspects, if the first packet of the stream belongs to a RTCP packet, a CID value that is not 0 will be allocated for the stream so as to preserve CID 0 for RTP packets. However, if the first packet is an RTP packet, then CID 0 is allocated for the stream. In other aspects, if the first packet is a non-TCP packet, a CID value that is not 0 will be allocated for the stream so as to preserve CID 0 for TCP packets. However, if the first packet belongs to a TCP packet, then CID allocation is allocated for the stream. In these aspects, the CID reservation uses one less octet compared to not reserving CID 0 for RTP or TCP packets.

At 706, the first device generates a compressed header for the first packet according to the header compression protocol and based on the determined CID. The RoHC manager 615 of the first device generates this compressed header and transmits the compressed header to the transmitter 620. In some aspects, the compressed header has a reduced payload size when generated based on the reserved CID value. For example, assigning CID 0 results in a reduced payload size for the more frequent RTP packet, and thereby results in higher compressor efficiency as shown in FIG. 8.

At 708, the first device transmits the first packet with the compressed header. The transmitter 620 transmits the first packet with the compressed header from the RoHC manager 615. By doing so, the first device indicates the CID allocation of the first packet and its corresponding packet type to a second device for future data packet transmission for the stream.

In some cases, the operations 700 may be performed by a device utilizing the RoHC compression protocol. In such cases, determining a CID based on packet type may help avoid allocating CID 0 to RTCP packets, even when the first incoming packet is an RTCP packet. As noted above, headers for packet with CID 0 have less payload than headers for packets with non-zero CIDs. Because RTCP packets occur much less often than RTP packets, avoiding allocating CID 0 to RTCP packets may lead to significant gains in overall header payload reduction bandwidth utilization.

As noted above, FIG. 8 illustrates how allocating CID 0 for the first incoming packet based on the packet type results in increased compressor efficiency. This increased compressor efficiency between allocating CID 0 for the first incoming packet as compared to reserving CID 0 for RTP packets can be seen in FIG. 8. As illustrated in FIG. 8, RoHC compressor efficiency when CID 0 is allocated based on the first incoming packet, regardless of packet type, may be less than 88%. Reserving CID 0 allocation for RTP packets, as described herein may result in a RoHC compressor efficiency greater than 89%, which is an overall increase of 1%.

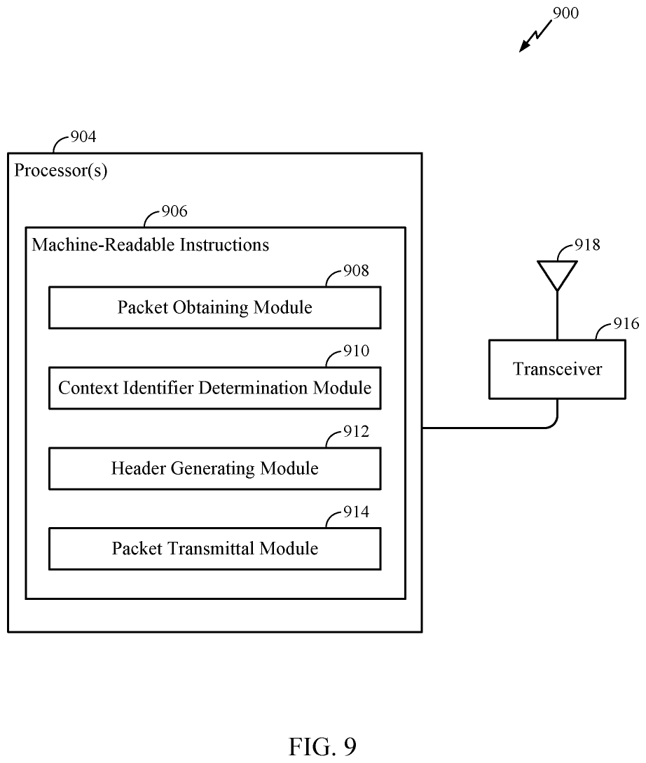

FIG. 9 illustrates a communications device 900 that may include various components (e.g., corresponding to means-plus-function components) configured to perform operations for the techniques disclosed herein, such as the operations illustrated in FIG. 7. The communications device 900 includes a processing system 904 (e.g., with one or more processors) coupled to a transceiver 914. The transceiver 914 is configured to transmit and receive signals for the communications device 900 via an antenna 916, such as the various signal described herein. The processing system 904 may be configured to perform processing functions for the communications device 900, including processing signals received and/or to be transmitted by the communications device 900.

The processing system 904 may include or be coupled to a computer-readable medium/memory 1006. In certain aspects, the computer-readable medium/memory 906 is configured to store instructions that when executed by processors 904, cause the processor 904 to perform the operations illustrated in FIG. 7, or other operations for performing the various techniques discussed herein.

In certain aspects, the processing system 904 and medium/memory 906 may implement a packet obtaining module/component 908 for performing the operations illustrated in FIG. 7 at 702, a context identifier determination module/component 910 for performing the operations illustrated in FIG. 7 at 704, a header generating module/component 912 for performing the operations illustrated in FIG. 7 at 706, and a packet transmittal module/component 914 for performing the operations illustrated in FIG. 7 at 708.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, various operations 700 shown in FIG. 7 may be performed by various processors shown in FIG. 4. More particularly, operations 700 of FIG. 7 may be performed by one or more of processors 466, 458, 464, and/or controller/processor 480 of the UE 120 or by processors 420, 430, 438, and/or controller/processor 440 of the BS 110 shown in FIG. 4

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a first device, comprising:
obtaining a first packet of a stream to be sent using a header compression protocol;
determining a context identifier (CID) to associate with the stream based, at least in part, on a packet type of the first packet;
generating a compressed header for the first packet according to the header compression protocol and based on the determined CID; and
transmitting the first packet with the compressed header.

2. The method of claim 1, wherein the header compression protocol comprises the robust header compression (RoHC) protocol.

3. The method of claim 1, wherein the CID is determined based on a rule that reserves a certain CID value for a certain packet type.

4. The method of claim 3, wherein the compressed header has a reduced payload size when generated based on the reserved CID value.

5. The method of claim 4, wherein determining the CID comprises assigning a zero CID value to the packet type, and the packet type comprising Real Time Protocol (RTP).

6. The method of claim 3, wherein the certain packet type comprises RTP.

7. The method of claim 3, wherein the reserved CID value is 0.

8. The method of claim 3, wherein the certain packet type comprises Transmission Control Protocol (TCP).

9. The method of claim 1, wherein the first device comprises a user equipment (UE).

10. The method of claim 1, wherein the first device comprises a base station (BS).

11. The method of claim 1, wherein the stream is for a voice call.

12. The method of claim 11, wherein the voice call is selected from a group consisting of: Voice-over-LTE (VoLTE), Voice-over-HSPA, and Voice-over-NR (VoNR).

13. The method of claim 1, wherein the stream is for a TCP data call.

14. An apparatus for wireless communications, comprising:
a receiver configured to obtain a first packet of a stream to be sent using a header compression protocol; and
at least one processor configured to:
determine a context identifier (CID) to associate with the stream based, at least in part, on a packet type of the first packet;
generate a compressed header for the first packet according to the header compression protocol and based on the determined CID; and
transmit the first packet with the compressed header; and
a memory coupled to the at least one processor.

15. The apparatus of claim 14, wherein the header compression protocol comprises the robust header compression (RoHC) protocol.

16. The apparatus of claim 14, wherein the CID is determined based on a rule that reserves a certain CID value for a certain packet type.

17. The apparatus of claim 16, wherein the compressed header has a reduced payload size when generated based on the reserved CID value.

18. The apparatus of claim 17, wherein the at least one processor is further configured to assign a zero CID value to the packet type, the packet type comprising Real Time Protocol (RTP).

19. The apparatus of claim 16, wherein the certain packet type comprises RTP.

20. The apparatus of claim 16, wherein the reserved CID value is 0.

21. The apparatus of claim 16, wherein the certain packet type comprises Transmission Control Protocol (TCP).

22. The apparatus of claim 14, wherein the apparatus comprises a user equipment (UE).

23. The apparatus of claim 14, wherein the apparatus comprises a base station (BS).

24. The apparatus of claim 14, wherein the stream is for a voice call.

25. The apparatus of claim 24, wherein the voice call is selected from a group consisting of: Voice-over-LTE (VoLTE), Voice-over-HSPA, and Voice-over-NR (VoNR).

26. The apparatus of claim 14, wherein the stream is for a TCP data call.

27. An apparatus for wireless communications, comprising:
means for obtaining a first packet of a stream to be sent using a header compression protocol;
means for determining a context identifier (CID) to associate with the stream based, at least in part, on a packet type of the first packet;
means for generating a compressed header for the first packet according to the header compression protocol and based on the determined CID; and
means for transmitting the first packet with the compressed header.

28. A computer readable medium having instruction stored thereon for:
obtaining a first packet of a stream to be sent using a header compression protocol;
determining a context identifier (CID) to associate with the stream based, at least in part, on a packet type of the first packet;
generating a compressed header for the first packet according to the header compression protocol and based on the determined CID; and
transmitting the first packet with the compressed header.
